(19) United States
(12) Patent Application Publication
(10) Pub. No.: US 2023/0137179 A1
(43) Pub. Date: May 4, 2023

(54) ELECTRICALLY CONDUCTIVE STRUCTURES

(71) Applicant: Hewlett-Packard Development Company, L.P., Spring, TX (US)

(72) Inventors: John L. Taylor, Corvallis, OR (US); Scott Sayer, Corvallis, OR (US); Eleanor Sarah Wright, Vancouver, WA (US)

(73) Assignee: Hewlett-Packard Development Company, L.P., Spring, TX (US)

(21) Appl. No.: 17/912,084

(22) PCT Filed: Mar. 30, 2020
(86) PCT No.: PCT/US2020/025672

§ 371 Date: Sep. 16, 2022

(51) Int. Cl. B41J 2/175

(52) U.S. Cl. CPC B41J 2/17526

(57) ABSTRACT

Examples of fluid reservoirs are described herein. In some examples, a fluid reservoir includes a routing. In some examples, the fluid reservoir includes a structure contacting the routing. In some examples, the structure contacts fluid in the fluid reservoir. In some examples, the structure includes carrier material and electrically conductive non-metal material.

### BACKGROUND

Some types of printing utilize liquid. For example, some types of printing extrude liquid onto media or material to produce a printed product (e.g., two-dimensional (2D) printed content, three-dimensional (3D) printed objects). In some examples, a printhead may be utilized to extrude ink onto paper to print text and/or images. In some examples, a printhead may be utilized to extrude fusing agent onto powder in order to form a 3D printed object.

### BRIEF DESCRIPTION OF THE DRAWINGS

FIG. 1 is a diagram illustrating a perspective view of an example of a fluid reservoir;

FIG. 2 is a diagram illustrating examples of a graphite-loaded plastic pins;

FIG. 3 is a diagram illustrating an exploded view of an example of a print cartridge;

FIG. 4 is a flow diagram illustrating one example of a method for manufacturing a fluid reservoir;

FIG. 5A is a diagram illustrating a perspective view of an example of a fluid reservoir well; and

FIG. 5B is a diagram illustrating a cross-sectional view of an example of the conductive non-metal structure described in relation to FIG. 5A.

### DETAILED DESCRIPTION

Some issues arise in the context of storing and/or utilizing fluids. A fluid is a liquid substance. In some examples, a fluid may damage (e.g., corrode, etch, etc.) a material or materials in contact with the fluid. For instance, electrochemical reactions may occur at an interface between fluid and material. In some examples, the electrochemical reactions may cause etching, where some or all of the material may move into the fluid.

An open circuit potential is a naturally occurring voltage that may occur due to electrochemical reactions at an interface between fluid and material (e.g., solid material). In some examples, the material may be silicon or may include silicon (e.g., silicon-based circuitry). In some examples, electrochemical reactions may cause etching of silicon into fluid that is in contact with the silicon.

In some examples, a voltage may be applied to the material (e.g., silicon). For instance, if a positive voltage is applied to silicon, the etching may increase. A high enough voltage may promote passivation (e.g., oxidation of the silicon surface). In some examples, a passivated surface may etch more slowly than a plain surface. For instance, a passivated silicon surface may etch more slowly than a plain silicon surface.

Some examples of the techniques described herein may reduce, mitigate, and/or neutralize the open circuit potential in order to reduce, mitigate, and/or neutralize etching at an interface between a fluid and a material. For instance, a conductive material may be electrically connected to a material (e.g., silicon). The conductive material may form a galvanic couple with the material, which may change the open circuit potential (e.g., between fluid and silicon). In some examples, the changed open circuit potential may be high enough to place the material into a passivation range, without applying an external bias.

In some examples, the foregoing issues may arise in the context of fluid reservoirs. A fluid reservoir is a container for fluid. Examples of fluid reservoirs include print liquid containers, print cartridges, print liquid supplies, etc. Print liquid is a fluid for printing. Examples of print liquid include ink and fusing agent. In some examples, a material that is prone to etching in print liquid may be exposed to the print liquid. For example, silicon circuitry (e.g., silicon printhead circuitry and/or other circuitry) may be in contact with the print liquid. Etching of the silicon circuitry may occur, which may cause circuitry failure and/or contamination of the print liquid. Accordingly, it may be beneficial to reduce, mitigate, and/or neutralize etching of a material in contact with a fluid.

In some examples, fluid reservoirs (e.g., print cartridges) may be constructed of thermoplastics. Thermoplastics may be injection molded and may be compatible with high volume manufacturing and/or assembly methods. It may be beneficial for the construction materials (e.g., materials to construct components of fluid reservoirs) to be compatible with print liquid and/or to be robust to environmental conditions over the life of the fluid reservoir. In some examples, fluid reservoirs may be constructed from thermoplastics such as polypropylene (PP), low-density polyethylene (LDPE), high-density polyethylene (HDPE), polyethylene terephthalate (PET), polycarbonate (PC), and/or blends thereof (e.g., copolymers such as a polypropylene-polyethylene blend). Some thermoplastics may be compatible with high volume assembly methods such as injection molding and/or welding. Welding is an action where materials fuse together. For example, welding may form bonds (e.g., molecular bonds) between materials. In some examples, welding materials may include a phase change of (e.g., melting and/or liquifying), intermingling, and/or mixing the materials. In some examples, welding may be capable of creating waterproof seals to contain the print liquid. In some examples, welding may occur without another bonding agent, additional part, adhesive, and/or sealant.

Throughout the drawings, identical reference numbers may designate similar, but not necessarily identical, elements. Similar numbers may indicate similar elements. When an element is referred to without a reference number, this may refer to the element generally, without necessary limitation to any particular figure. The figures are not necessarily to scale, and the size of some parts may be exaggerated to more clearly illustrate the example shown. Moreover, the drawings provide examples and/or implementations in accordance with the description; however, the description is not limited to the examples and/or implementations provided in the drawings.

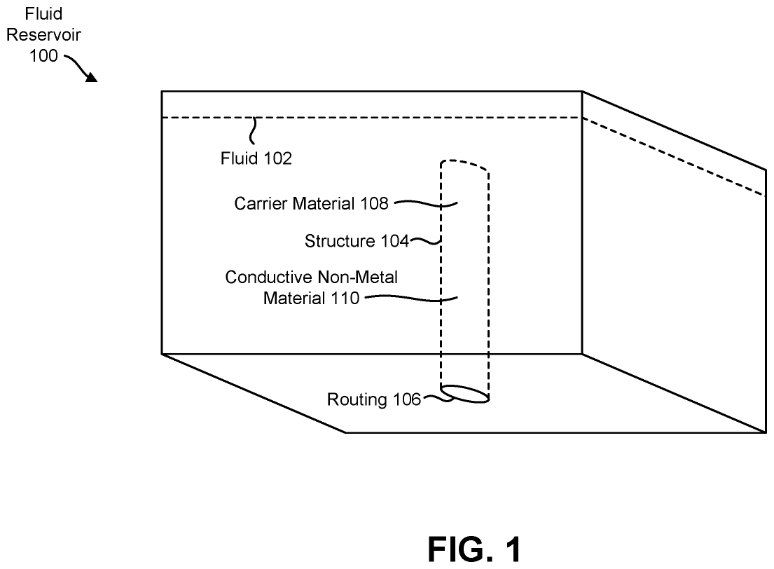

FIG. 1 is a diagram illustrating a perspective view of an example of a fluid reservoir 100. Examples of the fluid reservoir 100 include print liquid supplies, print liquid containers, print cartridges, etc. The fluid reservoir 100 may contain and/or transfer fluid 102 (e.g., print liquid, ink, agent, etc.). In some examples, the fluid reservoir 100 may be designed to interface with a host device. A host device is a device that uses and/or applies fluid 102. Examples of a host device include printers, ink jet printers, 3D printers, etc. In some examples, it may be beneficial to replenish or replace the fluid reservoir 100 when some or all of the fluid 102 has been utilized.

The fluid reservoir 100 may include a barrier or barriers (e.g., wall(s)) for containing the fluid 102 (e.g., print liquid). For example, the fluid reservoir 100 may be made of a plastic, polymer, resin, thermoplastic (e.g., PP, LDPE, HDPE, PET, PC, copolymers, etc.), etc., or a combination of thermoplastics. For instance, the fluid reservoir 100 or a portion of the fluid reservoir 100 may be molded (e.g., injection molded) from a thermoplastic or thermoplastics.

The fluid reservoir 100 may include a routing 106. A routing is a channel, passage, slot, or opening in a material. For example, the routing 106 may be a channel (e.g., passage through a wall) between an inside of the fluid reservoir 100 and an outside of the fluid reservoir 100.

The fluid reservoir 100 may include a structure 104 contacting the routing 106 and the fluid 102 in the fluid reservoir 100. The structure 104 may include carrier material 108 and electrically conductive non-metal material 110. A carrier material 108 is a material that supports or carries another material. Some examples of the carrier material 108 may include plastics, polymers, resins, thermoplastics (e.g., PP, LDPE, HDPE, PET, PC, copolymers, etc.), etc., or a combination of thermoplastics. For instance, the carrier material 108 may include a polymer.

An electrically conductive non-metal material is a material that is electrically conductive and is not a metal. For example, the electrically conductive non-metal material 110 may be or may include graphite or carbon-graphite. In some examples, the electrically conductive non-metal material 110 may include graphite fibers. For example, the structure 104 may include a combination of polymer and graphite (e.g., graphite fibers in a resin). For instance, the structure 104 may include graphite fibers embedded in and/or through the structure 104 (e.g., carrier material 108). It may be beneficial to utilize conductive non-metal material instead of metal for electrical conduction in some examples. For instance, some conductive non-metal materials (e.g., graphite) may be less expensive than some metals (e.g., gold). Some conductive non-metal materials (e.g., graphite) may be more durable and/or less prone to damage than some metals (e.g., gold). For instance, a graphite-loaded plastic pin may be less prone to scratching and/or failure than a gold-coated pin. Some combinations of a conductive non-metal material (e.g., graphite) and carrier material (e.g., polymer, plastic, etc.) may provide some improved manufacturing properties relative to some metals (e.g., gold). For instance, a combination of graphite and plastic may provide better molding, welding, and/or sealing properties with plastics than gold.

In some examples, the structure 104 is an elongated structure that protrudes into the fluid reservoir 100. For instance, an elongated structure may be longer than wide (or one dimension of the structure may be greater than another). In some examples, the structure 104 may be cylindrical, polygonal, prismatic, rectangular, symmetrical, asymmetrical, irregularly shaped, etc. As used herein, the term “cylindrical” may mean curved over a length. For example, “cylindrical” may denote a curved, circular, elliptical, conical, etc., shape over a length. A cylindrical structure may be partially cylindrical (e.g., cylindrical on a part of the structure) or may be cylindrical over a dimension of the structure. In some examples, cylindrical structures may be beneficial with a rotationally symmetrical shape that may oriented with any rotational orientation in a molding tool. Other shapes may be utilized in some examples.

In some examples, a portion of the structure 104 may be disposed on an outside of the fluid reservoir 100. For example, the structure 104 (e.g., a portion of the structure 104) may be situated through the routing 106. A portion of the structure 104 may be disposed outside of the fluid reservoir 100, and a portion of the structure 104 may be disposed within the fluid reservoir 100. The structure 104 may provide electrical conduction between the outside of the fluid reservoir 100 and the inside of the fluid reservoir 100.

In some examples, the structure 104 may be welded to the routing 106 of the fluid reservoir 100. In some examples, the welding between the structure 104 and the routing 106 may form a waterproof seal, which may prevent the fluid 102 from flowing out of the routing 106. For example, welding may occur during attachment of the structure 104 to the routing 106. In some examples, welding may occur during molding of the routing 106 (e.g., barrier or wall of the fluid reservoir) around the structure 104. For instance, liquid material (e.g., polymer) may be injection molded around a portion of the structure 104 to form the fluid reservoir 100 or a portion of the fluid reservoir 100 (e.g., routing 106). The heat of the liquid material may cause the structure 104 or a portion of the structure 104 (e.g., carrier material 108) to undergo a phase change or partial phase change (e.g., melting, partial liquefaction, etc.), which may weld and/or bond the structure 104 to the routing 106 as the routing 106 cools and/or solidifies. In some examples, the structure 104 (e.g., carrier material 108 of the structure 104) and the routing 106 may have an overlapping melting temperature range. Some examples of melting temperatures of materials that may be utilized for the fluid reservoir 100, routing 106, and/or carrier material 108 of the structure 104 are given as follows. Polypropylene may have a melting temperature of approximately 160 degrees Celsius (C). With a blended copolymer (e.g., polypropylene with polyethene), melting temperatures may be within a range between approximately 130 C and 160 C depending on the blend.

In some examples, the structure 104 may be press-fit to the routing 106. For instance, the structure 104 may include a press-fit lead-in shape. Some examples may utilize molding or press-fitting, or molding and press-fitting to attach the structure 104 to the routing 106.

In some examples, silicon or silicon circuitry (not shown in FIG. 1) may be in contact with the fluid 102. The structure 104 may be utilized to mitigate (e.g., reduce, neutralize) an electrical potential (e.g., open circuit potential) between the silicon and the fluid 102. Mitigating the electrical potential may reduce etching of the silicon. Etching of the silicon may result in degradation and/or failure of silicon circuitry (e.g., printhead).

In some examples, the fluid reservoir 100 may be part of the print cartridge. For instance, a print cartridge may include a printhead (not shown in FIG. 1). A printhead is a structure and/or circuitry to extrude fluid (e.g., print liquid). In some examples, a printhead may include (e.g., may be manufactured with) silicon structure(s) and/or silicon-based circuitry. The printhead may be in contact with the fluid 102. For example, silicon printhead circuitry may include a feed hole or feed holes. The feed hole(s) may permit fluid 102 (e.g., print liquid, ink, agent, etc.) to pass from the fluid reservoir 100 to be extruded by the printhead onto media.

In some examples, the structure 104 may be utilized to mitigate an electrical potential between the printhead and the fluid 102. In some examples, the structure 104 may be coupled to grounding circuitry through the routing 106. Grounding circuitry is a conductor, connection, and/or circuitry. For example, grounding circuitry may be a conductor, connection, and/or circuitry at a potential (e.g., reference potential, 0 volts (V), etc.), and/or may be a return path (e.g., common return path) for current.

In some examples, grounding circuitry may be coupled to a printhead. For instance, the grounding circuitry may be coupled to both the structure 104 and to a printhead that is in contact with the fluid 102. The structure 104 may mitigate (e.g., reduce, neutralize, etc.) an electrical potential between the printhead and the fluid 102. For example, the grounding circuitry coupled to the structure 104 and to the printhead may reduce a voltage between the fluid 102 and the printhead to a relatively small difference or zero. In some examples, the printhead may include silicon, and the structure 104 may reduce fluid etching of the silicon by mitigating the electrical potential.

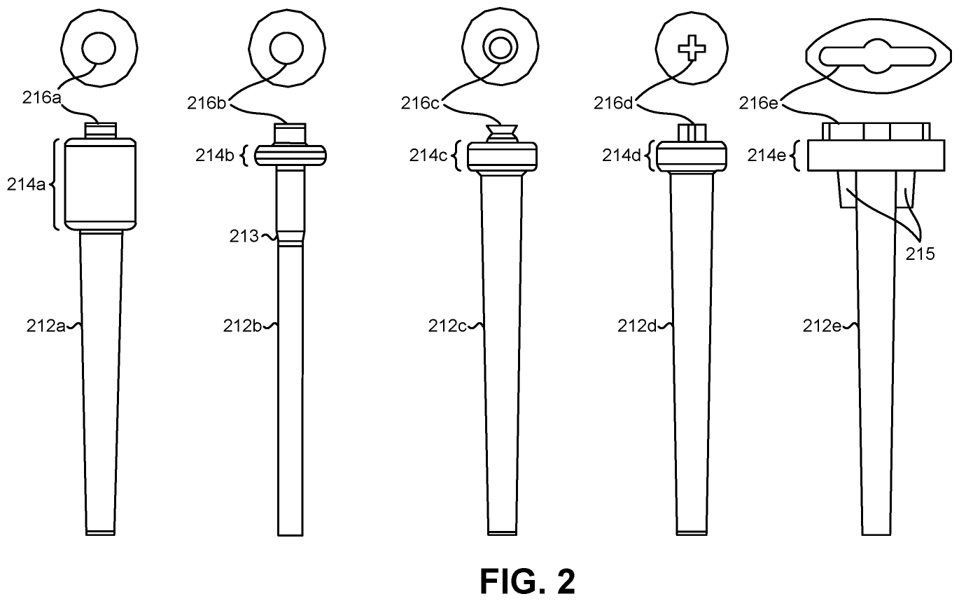

FIG. 2 is a diagram illustrating examples of a graphite-loaded plastic pins 212a—e. The graphite-loaded plastic pins 212a—e may be examples of the structure 104 described in relation to FIG. 1. For example, each of the graphite-loaded plastic pins 212a—e may include carrier material (e.g., plastic) and electrically conductive non-metal material (e.g., graphite). Each of the examples illustrates a top-down view and an elevation view of the graphite-loaded plastic pins 212a—e.

A first graphite-loaded plastic pin 212a may include a first bulge 214a and a first head 216a. A head of a structure is an end portion of the structure. For example, the first head 216a may be a cylindrical structure at an end of the first graphite-loaded plastic pin 212a. A bulge is a portion of a structure that is larger than another portion of the structure in a dimension. For example, the first bulge 214a is larger in width or diameter relative to a shaft portion of the first graphite-loaded plastic pin 212a. A shaft portion is a portion of a structure from a bulge to an end of the structure opposite from the head. An end portion of the first head 216a may be disposed on an outside of a fluid reservoir. In some examples, the end portion of the first head 216a may be coupled to grounding circuitry through a routing. In some examples, a portion of the first bulge 214a may be disposed within the routing and/or may be welded to the routing. For instance, a head of the structure may be placed in a mold (e.g., in a mold depression) for molding a fluid reservoir. A side of a bulge may be in contact with the mold during molding (e.g., a side towards the head). During molding, liquid material (e.g., polymer) may flow or be injected around a portion of a bulge to form a routing. The portion of the bulge may weld to the liquid material (e.g., routing). In some examples, another portion of the first bulge 214a may be situated in an inside of a fluid reservoir and/or may be in contact with the fluid. The first bulge 214a may be approximately 3 millimeters (mm) in length. The first bulge 214a may provide greater moldability (e.g., may be easier to manufacture) due to a larger length (in comparison with other bulges 214b—d, for example, where the second bulge 214b may have a length of 0.7 mm).

A shaft portion of the first graphite-loaded plastic pin 212a may be situated in an inside of the fluid reservoir and/or may be in contact with the fluid. The shaft portion of the first graphite-loaded plastic pin 212a may be conical in shape. For example, the shaft portion may taper to a smaller diameter (over a portion of the length or over the entire length of the shaft portion, for instance) towards an end that is opposite from the first head 216a. A shaft diameter of the first graphite-loaded plastic pin 212a may be 400 micrometers (μm) larger than a shaft diameter of a second graphite-loaded plastic pin 212b. A larger diameter shaft may provide a larger surface area that is in contact with the fluid, which may increase the efficacy of the structure in reducing or neutralizing etching. For instance, the first graphite-loaded plastic pin 212a may have a surface area of 49.6 mm² in contact with fluid, while the second graphite-loaded plastic pin 212b may have a surface area of 26.6 mm² in contact with fluid.

A second graphite-loaded plastic pin 212b may include a second bulge 214b and a second head 216b. The second head 216b may be a cylindrical structure at an end of the second graphite-loaded plastic pin 212b. An end portion of the second head 216b may be disposed on an outside of a fluid reservoir. In some examples, the end portion of the second head 216b may be coupled to grounding circuitry through a routing. In some examples, a portion of the second bulge 214b (e.g., an entire outer circumference) may be disposed within the routing and/or may be welded to the routing. The portion of the second bulge 214b may weld to the liquid material (e.g., routing). In some examples, the second bulge 214b may not be in contact with the fluid. The second bulge 214b may be approximately 0.7 mm in length. The second bulge 214b may provide less moldability (e.g., may be more difficult to manufacture) due to a shorter length (in comparison with the first bulge 214a, for example).

A shaft portion of the second graphite-loaded plastic pin 212b (or a portion of the shaft portion, for example) may be situated in an inside of the fluid reservoir and/or may be in contact with the fluid. The shaft portion of the second graphite-loaded plastic pin 212b may be cylindrical in shape with a taper 213 over a portion of the shaft (which may be utilized as a press-fit lead-in in some examples). For example, the shaft portion may taper to a smaller diameter (over the portion of the length of the shaft portion, for instance) towards an end that is opposite from the second head 216b.

A third graphite-loaded plastic pin 212c may include a third bulge 214c and a third head 216c. The third head 216c may be an undercut cylindrical structure at an end of the third graphite-loaded plastic pin 212c. The undercut is a narrowed portion of the head. In some examples, the undercut may provide a mechanical interlock with conductive adhesive for coupling the third head 216c to grounding circuitry. An end portion of the third head 216c may be disposed on an outside of a fluid reservoir. In some examples, the end portion of the third head 216c may be coupled to grounding circuitry through a routing. In some examples, a portion of the third bulge 214c (e.g., an entire outer circumference) may be disposed within the routing and/or may be welded to the routing (during molding, for example). In some examples, the third bulge 214c may not be in contact with the fluid. The third bulge 214c may be approximately 1 mm in length.

A shaft portion of the third graphite-loaded plastic pin 212c (or a portion of the shaft portion, for example) may be situated in an inside of the fluid reservoir and/or may be in contact with the fluid. The shaft portion of the third graphite-loaded plastic pin 212c may be conical in shape with a taper over the shaft. For example, the shaft portion may taper to a smaller diameter (over the length of the shaft portion, for instance) towards an end that is opposite from the third head 216c.

A fourth graphite-loaded plastic pin 212d may include a fourth bulge 214d and a fourth head 216d. The fourth head 216d may be a cross-shaped structure at an end of the fourth graphite-loaded plastic pin 212d. In some examples, the cross-shaped structure may provide increased surface area for conductive adhesive for coupling the fourth head 216d to grounding circuitry. An end portion of the fourth head 216d may be disposed on an outside of a fluid reservoir. In some examples, the end portion of the fourth head 216d may be coupled to grounding circuitry through a routing. In some examples, a portion of the fourth bulge 214d (e.g., an entire outer circumference) may be disposed within the routing and/or may be welded to the routing (during molding, for example). In some examples, the fourth bulge 214d may not be in contact with the fluid. The fourth bulge 214d may be approximately 1 mm in length.

A shaft portion of the fourth graphite-loaded plastic pin 212d (or a portion of the shaft portion, for example) may be situated in an inside of the fluid reservoir and/or may be in contact with the fluid. The shaft portion of the fourth graphite-loaded plastic pin 212d may be conical in shape with a taper over the shaft. For example, the shaft portion may taper to a smaller diameter (over the length of the shaft portion, for instance) towards an end that is opposite from the fourth head 216d.

A fifth graphite-loaded plastic pin 212e may include a fifth bulge 214e and a fifth head 216e. The fifth head 216e may be a partially cylindrical structure with an integrated rail at an end of the fifth graphite-loaded plastic pin 212e. The fifth graphite-loaded plastic pin 212e may also include wing structures 215. In some examples, the wing structures 215 may act as keying features to orient the pin 212e in a mold tool, as the pin 212e is not rotationally symmetrical. The wing structures 215 may fit into negative spaces in the mold tool to hold the pin 212e to provide a target orientation and/or rotation relative to the mold tool. In some examples, the partially cylindrical structure with a rail may provide a surface on which to dispense conductive adhesive. Using the rail as a dispense surface for conductive adhesive may enable a line dispense (rather than a dollop dispense, for instance). In some examples, a line dispense may be easier to control during processing. For instance, other dispensing approaches may have more factors to control when separately starting and stopping dispensing. An end portion of the fifth head 216e may be disposed on an outside of a fluid reservoir. In some examples, the end portion of the fifth head 216e may be coupled to grounding circuitry through a routing. In some examples, a portion of the fifth bulge 214e (e.g., an entire outer circumference) may be disposed within the routing and/or may be welded to the routing (during molding, for example). In some examples, the fifth bulge 214e may not be in contact with the fluid. The fifth bulge 214e may be approximately 1 mm in length.

A shaft portion of the fifth graphite-loaded plastic pin 212e (or a portion of the shaft portion, for example) may be situated in an inside of the fluid reservoir and/or may be in contact with the fluid. The shaft portion of the fifth graphite-loaded plastic pin 212e may be conical in shape with a taper over the shaft. For example, the shaft portion may taper to a smaller diameter (over the length of the shaft portion, for instance) towards an end that is opposite from the fifth head 216e.

In some examples, features of the graphite-loaded plastic pins 212a— e may be interchanged. For example, the third head 216c or the fourth head 216d may be interchanged with the first head 216a to produce a graphite-loaded plastic pin with the first bulge 214a and shaft structure. Other variations may be implemented.

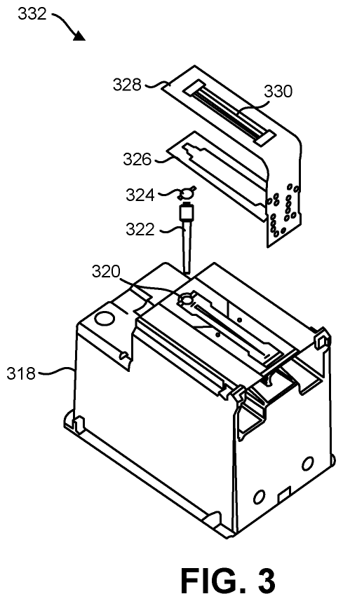

FIG. 3 is a diagram illustrating an exploded view of an example of a print cartridge 332. In some examples, a print cartridge may include a body containing print liquid and a graphite-loaded plastic pin disposed within the body and in contact with the print liquid. The pin may pass from an inside of the body to an outside of the body. In the example illustrated in FIG. 3, the print cartridge 332 includes flexible circuitry 328, a printhead 330, an intervening structure 326, a conductive adhesive 324, a graphite-loaded plastic pin 322, and a body 318 that includes a routing 320. In some examples, a print cartridge may not include all of the components described in relation to FIG. 3.

In some examples, the body 318 may be an example of the fluid reservoirs described herein (e.g., fluid reservoir 100 described in relation to FIG. 1). In some examples, the graphite-loaded plastic pin 322 may be an example of the structure 104 described in relation to FIG. 1 and/or of the graphite-loaded plastic pins 212a—e described in relation to FIG. 2. In some examples, the flexible circuitry 328 may be an example of the grounding circuitry described in relation to FIG. 1 and/or FIG. 2. In some examples, the routing 320 may be an example of the routings described in relation to FIG. 1 and/or FIG. 2 (e.g., routing 106).

In some examples, the flexible circuitry 328 may include a flexible layer or layers and a metal trace or traces. In some examples, the layer(s) may be polyimide (PI), polyethylene naphthalate (PEN), polyethylene terephthalate (PET), and/or other material(s), etc. In some examples, the layer(s) may isolate and/or protect the metal traces. For instance, the metal trace(s) may be embedded within (e.g., sandwiched between) layers. In some examples, each metal trace may include copper, nickel, palladium, gold, and/or other metal(s). In some examples, metal traces may have a thickness between 8 and 70 microns (e.g., 20 microns, 35 microns, etc.). In some examples, a flexible layer may have a thickness between 10 microns and 200 microns. In some examples, the metal trace(s) may include the grounding circuitry and/or other traces (e.g., traces for carrying control signal(s) to the printhead 330). In some examples, the flexible circuitry 328 may include a contact pad for coupling the grounding circuitry of the flexible circuitry 328 to a ground or common connection of a host device. A contact pad is a metal pad for contacting an interfacing structure (e.g., spring connectors, pins, etc.).

In some examples, the printhead 330 (e.g., silicon printhead circuitry) may be coupled to the flexible circuitry 328. For example, the printhead 330 may be attached to the flexible circuitry 328 with wire bonds and/or adhesive. Examples of wire bonds may include metal plates, balls, pads, etc., that may be utilized to connect to (e.g., bond to, fuse to, join with, etc.) a wire or other connector.

In some examples, the body 318 may contain print liquid (e.g., ink, agent, etc.). The graphite-loaded plastic pin 322 may be disposed within (e.g., partially within) the body 318. The graphite-loaded plastic pin 322 may be in contact with the print liquid. The graphite-loaded plastic pin 322 may pass from inside the body 318 to outside the body 318. For example, the graphite-loaded plastic pin 322 may be situated or positioned within the body 318 through the routing 320. A head of the graphite-loaded plastic pin 322 may be disposed outside of the body 318.

In some examples, the body 318 may be welded to the graphite-loaded plastic pin 322. For example, the body 318 may be molded around the graphite-loaded plastic pin 322, such that carrier material of the graphite-loaded plastic pin 322 may be bonded and/or welded to the body 318.

In some examples, the flexible circuitry 328 may be coupled to the graphite-loaded plastic pin 322. For example, conductive adhesive 324 may couple a portion (e.g., a conductive pad, a copper pad, etc.) of the flexible circuitry 328 to the graphite-loaded plastic pin 322. For instance, the conductive adhesive 324 may be applied to the graphite-loaded plastic pin 322 and/or to the flexible circuitry 328 (e.g., a conductive pad, copper pad, etc.), which may allow conduction between the graphite-loaded plastic pin 322 and the flexible circuitry 328. In some examples, the conductive adhesive 324 may connect and/or adhere to the graphite-loaded plastic pin 322 and/or to the flexible circuitry 328.

In some examples, the flexible circuitry 328 may be coupled to the body 318. For example, an adhesive, welding, pressure fit, mechanical attachment, and/or other approach may be utilized to attach the flexible circuitry 328 to the body 318. In some examples, an intervening structure 326 may be disposed between the flexible circuitry 328 and the body 318. In some examples, the intervening structure 326 may be utilized to attach, interface, and/or seal the flexible circuitry 328 and/or printhead 330 to the body 318.

In some examples, the printhead 330 (e.g., silicon printhead circuitry) may include a print liquid feed hole or print liquid feed holes. For example, the feed hole(s) may provide a path or paths for the print liquid in the body 318 to be extruded by the printhead 330. In some examples, the feed hole(s) may be structured from silicon.

In some examples, the flexible circuitry 328 may reduce an electrical potential between the graphite-loaded plastic pin 322 and the printhead 330 (e.g., silicon printhead circuitry) to reduce etching of the feed holes. In some examples, reducing the electrical potential may be accomplished as described in relation to FIG. 1 and/or FIG. 2. For instance, the graphite-loaded plastic pin 322 may be coupled to the flexible circuitry 328, or to a conductive pad of the flexible circuitry 328 (using conductive adhesive 324, for example). The flexible circuitry 328 (e.g., a conductive pad, metal pad, copper pad, etc.) may be coupled to the printhead 330 (e.g., silicon printhead circuitry). For example, the graphite-loaded plastic pin 322 and the printhead 330 may be coupled to a grounding conductor (e.g., metal trace, ribbon, plate, etc.) of the flexible circuitry 328, which may reduce or neutralize the electrical potential between the graphite-loaded plastic pin 322 and the printhead 330. Reducing the electrical potential may reduce etching of the feed hole(s). For example, reducing the electrical potential may reduce an electrochemical reaction between the print liquid and the printhead 330 (e.g., feed hole(s)). For instance, the graphite-loaded plastic pin 322, the flexible circuitry 328, and the printhead 330 may enable conduction between the print fluid and the printhead 330 in contact with the print fluid, which may reduce the electrical potential.

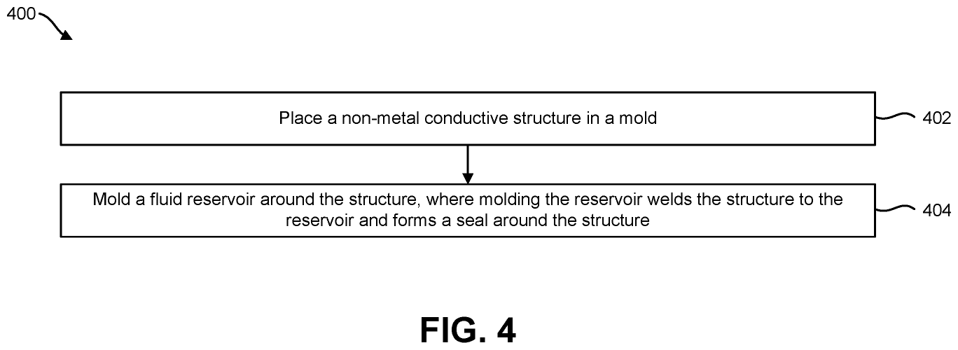

FIG. 4 is a flow diagram illustrating one example of a method 400 for manufacturing a fluid reservoir. In some examples, the method 400 may be performed by an assembly machine or machines. In some examples, the method 400 may be performed to produce the fluid reservoir 100 described in relation to FIG. 1 and/or the print cartridge 332 described in relation to FIG. 3. The method 400 may include placing 402 a conductive non-metal structure in a mold. For instance, a structure (e.g., structure 104 or graphite-loaded plastic pin 212a—e, 322, etc.) may be placed in a mold. In some examples, an end of the structure (e.g., end of a head of the structure) may be placed flush with a pocket floor in the mold (e.g., die). In some examples, a side or a portion of a side of a bulge may be placed flush with a pedestal of the mold.

The method 400 may include molding 404 a fluid reservoir around the structure. For example, molten polymer may be molded (e.g., injection molded) around the structure (e.g., around a circumference of the structure, around a circumference of a bulge of the structure, etc.). In some examples, molding the reservoir may weld the structure to the reservoir. In some examples, molding the reservoir around the structure may form a seal around the structure. In some examples, the structure includes a first polymer with graphite fibers. For instance, the first polymer may be a carrier material and the graphite fibers may be a conductive non-metal material of the structure. In some examples, the reservoir includes a second polymer.

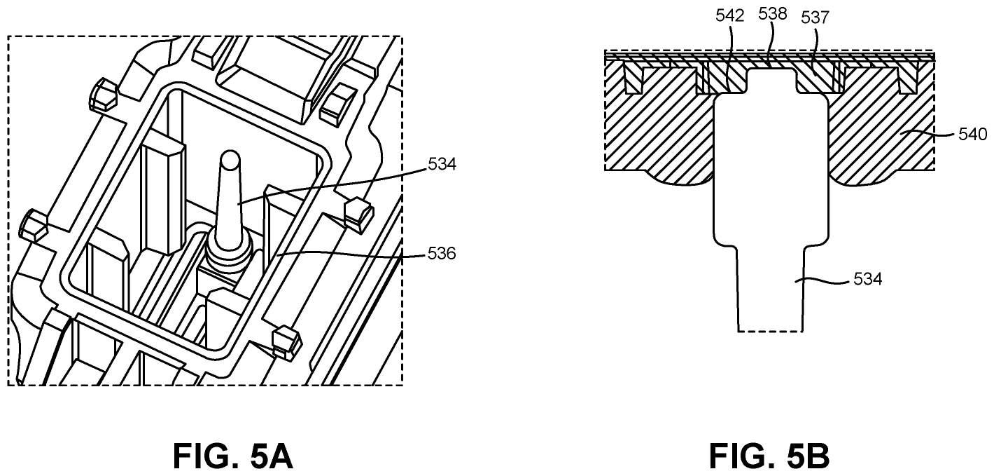

FIG. 5A is a diagram illustrating a perspective view of an example of a fluid reservoir well 536. The fluid reservoir well 536 may be an example of a rectangular reservoir well. For example, a mold with a positive rectangular feature may be utilized to form the fluid reservoir well 536. The fluid reservoir well 536 may be a portion of a fluid reservoir. As illustrated in FIG. 5A, a conductive non-metal structure 534 may be disposed in the fluid reservoir well 536. The conductive non-metal structure 534 may be an example of the structure 104 described in relation to FIG. 1 and/or an example of a graphite-loaded plastic pin 212a-212e, 322 described in relation to FIG. 2 or FIG. 3. In some examples, the conductive non-metal structure 534 may be placed in a mold, and the fluid reservoir well 536 may be molded around the conductive non-metal structure 534 as described herein.

FIG. 5B is a diagram illustrating a cross-sectional view of an example of the conductive non-metal structure 534 described in relation to FIG. 5A. A cross-sectional view of a portion of a mold 537 is also illustrated. As illustrated in FIG. 5B, an end of the conductive non-metal structure 534 is placed in a pocket 538 in the mold 537. A side or a portion of a side of the conductive non-metal structure 534 is also placed in contact with a pedestal 542 of the mold 537. Material 540 of a reservoir may be molded around the conductive non-metal structure 534 and/or may weld to the conductive non-metal structure 534, which may create a routing through the material 540 and/or a seal around the conductive non-metal structure 534.

As used herein, the term “and/or” may mean an item or items. For example, the phrase “A, B, and/or C” may mean any of: A (without B and C), B (without A and C), C (without A and B), A and B (but not C), B and C (but not A), A and C (but not B), or all of A, B, and C.

While various examples of techniques and structures are described herein, the techniques and structures are not limited to the examples. Variations of the examples described herein may be implemented within the scope of the disclosure. For example, operations, functions, aspects, or elements of the examples described herein may be omitted or combined.

1. A fluid reservoir, comprising:
a routing; and
a structure contacting the routing and fluid in the fluid reservoir, the structure comprising carrier material and electrically conductive non-metal material.

2. The fluid reservoir of claim 1, wherein the electrically conductive non-metal material comprises graphite.

3. The fluid reservoir of claim 1, wherein the electrically conductive non-metal material comprises graphite fibers.

4. The fluid reservoir of claim 1, wherein the carrier material comprises polymer.

5. The fluid reservoir of claim 1, wherein the structure is an elongated structure that protrudes into the fluid reservoir.

6. The fluid reservoir of claim 1, wherein the structure is coupled to grounding circuitry through the routing.

7. The fluid reservoir of claim 6, wherein the grounding circuitry is coupled to a printhead.

8. The fluid reservoir of claim 7, wherein structure is to mitigate an electrical potential between the printhead and the fluid.

9. The fluid reservoir of claim 8, wherein the printhead comprises silicon, and the structure is to reduce fluid etching of the silicon by mitigating the electrical potential.

10. The fluid reservoir of claim 1, wherein the structure is welded to the routing of the fluid reservoir.

11. A print cartridge, comprising:
a body containing print liquid; and
a graphite-loaded plastic pin disposed within the body and in contact with the print liquid, wherein the pin passes from an inside of the body to an outside of the body.

12. The print cartridge of claim 11, wherein the body is welded to the pin.

13. The print cartridge of claim 11, further comprising:
flexible circuitry coupled to the pin and to the body; and
silicon printhead circuitry coupled to the flexible circuitry, wherein the silicon printhead circuitry comprises print liquid feed holes, and wherein the flexible circuitry is to reduce an electrical potential between the pin and the silicon printhead circuitry to reduce etching of the feed holes.

14. A method, comprising:
placing a conductive non-metal structure in a mold; and
molding a reservoir around the structure, wherein molding the reservoir welds the structure to the reservoir and forms a seal around the structure.

15. The method of claim 14, wherein the structure comprises a first polymer with graphite fibers, and wherein the reservoir comprises a second polymer.
